(19) United States
(12) Patent Application Publication
(10) Pub. No.: US 2017/0124661 A1
(43) Pub. Date: May 4, 2017

(54) BOOK EXCHANGE PROCESS

(71) Applicant: Bolt Solutions Inc., New York, NY (US)

(72) Inventor: Ari KATZ, Savyon (IL)

(21) Appl. No.: 15/338,394

(22) Filed: Oct. 30, 2016

Related U.S. Application Data
(60) Provisional application No. 62/249,285, filed on Nov. 1, 2015.

(51) Int. Cl. G06Q 40/08; G06Q 30/06

(52) U.S. Cl. CPC G06Q 40/08; G06Q 30/0641

(57) ABSTRACT

Apparatus and method for electronic interaction between remote parties regarding a book of business over a network, the book containing elements such as insurance policies. A book exchange platform contains a first user input allow a first remote user to input said book including said plurality of elements, a user interaction interface to allow said first remote user to evaluate said book and said plurality of elements, a buyer interaction interface to allow any one of a plurality of remotely located potential buyers to evaluate said book and said plurality of elements, and a user offer input to receive an electronic signal to allow said first remote user to make an offer for sale of said book. Finally, a buy input allows potential buyers to make a selection of one or more elements of a book and to offer to buy the selected elements or entire book.

### RELATED APPLICATION

This application claims the benefit of priority under 35 USC 119(e) of U.S. Provisional Patent Application No. 62/249,285 filed on Nov. 1, 2015, the contents of which are incorporated herein by reference in their entirety.

### FIELD AND BACKGROUND OF THE INVENTION

The present invention, in some embodiments thereof, relates to electronic processing of insurance books in an electronic book exchange process and, more particularly, but not exclusively, to a process and a platform for allowing processing and exchange of insurance books between remotely located parties.

Insurance books are often traded for all kinds of reasons. An insurance company may wish to wind up operations, or may discover that its statistical spread is insufficient and sales of selected parts of the book may be needed to recover the intended risk profile.

There are a number of difficulties in trading insurance books, not least of which is the difficulty in organizing information for buyers. An insurance book is a complex product made up of different insurance contracts, each contract being in itself unique.

The complexity of the individual contracts leads to difficulty in determining a book value, and there is a lack of tools to support book analysis, which is a very specialized type of analysis. There are no systems to facilitate and support the transfer of the book and thus such a transfer is today typically carried out manually, based on estimation of the individual policies, non-standard manual operations and the risk of leakage of policies for the buyer. As a result, the process of transferring a book has not changed much since the very beginnings of the insurance industry. Even with automation, there are multiple parties with different computer systems and information needs that make the assessment and transfer of information complicated. In some cases, the process is so difficult it is easier to retain the book even though that is a costly operation, and often the complexity of the trade can lower the value.

In today's insurance industry there is a steady stream of mergers and acquisitions that trigger book transfers. When a carrier decides to exit a line of business or geography, the sale of a book of business is a complicated and onerous operation. These challenges often force the carrier to sell the book for a heavy discount. It is equally complex for the buyer of the book. The risks have to be assessed and decisions have to be made, usually with the added pressure of time.

The key problems may be summarized as follows:
It is difficult to organize information and package for a buyer
It is difficult to set the value of the book
There is a lack of the tools to support book analysis
The non-standardization and the difficulty in packaging may limit sales exposure to only a small number of parties, thus affecting price and may only allow organizations with a certain level of sophistication to make sales, thus limiting supply
There is a lack of flexibility in changing the set of contracts on offer
Complex operations are needed to close policies and allow for transfer of information upon renewal, as the buyer has to act in the place of the seller before the insured who presumably knows nothing about the book transfer
There are no systems to support monitoring of the transfer of the book
There is a problem of leakage of policies for the buyer as policies are renewed through (Do Not Quote) DNQ, meaning that the carrier does not want the specific risk, or shopping
There is a need to manage regulatory requirements for the transaction
The book transfer operation requires many non-standardized manual operations.

### SUMMARY OF THE INVENTION

The present embodiments provide an electronic platform allowing remote participants to engage transparently and carry out transactions relating to books of business, such as for example a book of insurance policies. The platform provides tools to analyze and evaluate the books, and exchange offers and acceptances regarding all or part of the books. Herein the term book is used to refer to groupings of elements such as insurance policies.

According to an aspect of some embodiments of the present invention, there is provided apparatus for electronic interaction between remote parties regarding a book over a network, the book comprising a plurality of elements, the apparatus comprising:
a first user input configured to receive an electronic signal to allow a first remote user to input said book including said plurality of elements;
a user interaction interface to receive an electronic signal to allow said first remote user to evaluate said book and said plurality of elements;
a buyer interaction interface to receive an electronic signal to allow any one of a plurality of remotely located potential buyers to evaluate said book and said plurality of elements;
a user offer input to receive an electronic signal to allow said first remote user to make an offer for sale of said book; and
a buy input to receive an electronic signal to allow one of said remote buyers to:

make a selection comprising one member of the group consisting of:

one of said plurality of elements of said book;

at least two of said plurality of elements of said book; and

all elements of said book; and

to offer to buy said selected elements.

The apparatus may be constructed using a software as a service cloud model, and the elements may be insurance contracts, so that the book is a book of insurance contracts.

In an embodiment, said insurance contracts carry risk and said evaluation interfaces are configured to evaluate respective risks. The user offer input may be configured to allow said first remote user to use evaluated risks of said book to set an offer price.

Embodiments may comprise a log-in unit, wherein said remote parties are insurance carriers and said first remote user and said plurality of remote buyers are respectively required to log in via said log-in unit as being associated with a corresponding one of said insurance carriers.

In an embodiment, said first user input is configured for uploading said book as a plurality of said elements in a plurality of formats.

Embodiments may comprise a book browsing interface to allow said prospective buyers to search through different books on said platform. The elements may comprise risk carrying insurance contracts as mentioned above, and said browsing interface is configured to allow for searching according to definable risk criteria.

An embodiment may comprise an offer browsing interface for browsing book offers.

According to a second aspect of the present invention, there is provided a method for electronic interaction between remote parties regarding a book over a network, the book comprising a plurality of elements, the method carried out on an electronic process connected to said remote users via said network, the method comprising:
receiving an electronic signal to allow a first remote user to input said book including said plurality of elements;
receiving an electronic signal to allow said first remote user to evaluate said book and said plurality of elements;
receiving an electronic signal to allow any one of a plurality of remotely located potential buyers to evaluate said book and said plurality of elements;
receiving an electronic signal to allow said first remote user to make an offer for sale of said book; and
receiving an electronic signal to allow one of said remote buyers to:

make a selection comprising one member of the group consisting of:

one of said plurality of elements of said book;

at least two of said plurality of elements of said book; and

all elements of said book; and

to offer to buy said selected elements.

Unless otherwise defined, all technical and/or scientific terms used herein have the same meaning as commonly understood by one of ordinary skill in the art to which the invention pertains.

Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified block diagram showing multiple parties using a book exchange according to embodiments of the present invention;

FIG. 2 is a simplified flow chart of the general use of the exchange, according to embodiments of the present invention;

FIG. 3 is a view in greater detail of the elements of the exchange of FIG. 1, according to embodiments of the present invention;

FIG. 4 is a simplified diagram showing in greater detail the elements of FIG. 3, according to embodiments of the present invention;

FIG. 5 is a simplified diagram showing in particular the elements involved in obtaining and providing a quote, according to embodiments of the present invention;

FIG. 6 is a simplified flow diagram showing upload of a book, according to embodiments of the present invention;

FIG. 7 is a simplified flow diagram showing placing an offer, according to embodiments of the present invention; and

FIG. 8 is a simplified diagram showing accepting and rejections offers, according to embodiments of the present invention.

### DESCRIPTION OF SPECIFIC EMBODIMENTS OF THE INVENTION

The present invention, in some embodiments thereof, relates to electronic processing of insurance books in an electronic book exchange process and, more particularly, but not exclusively, to a process and a platform for allowing processing and exchange of insurance books between remotely located parties.

The present embodiments may thus provide an electronic networked exchange for Books of Business to support the sale and transfer of books of business between insurance carriers. The exchange may allow carriers selling a book of business to upload, typically remotely, a set of policy information to a secure cloud, and have buyers, who again may be remotely located, able to analyze and select sets of polices to purchase from the selling carrier. The exchange, according to certain embodiments, may also support the download of policy information either in batch, or upon renewal so that risks can be transferred efficiently to the new carrier and removed from the selling carrier's book of business.

In an embodiment of the exchange, transparency is provided so that different purchasers may see the same information under the same terms. Sellers may thus be able to offer segments of books of business to multiple buyers simultaneously, creating an auction style environment. The exchange may thus create an efficient open transfer mechanism to enable a fair valuation of the transfer of risks from one carrier to another.

An added benefit to an exchange according to some of the present embodiments is that state regulators may have the same transparent access to the transactions and transfer. Regulatory costs and procedures may thus be possible, to simplify required regulatory oversight for the approach. Another benefit is that the buyer can quote the relevant book segments through the buyer infrastructure to determine pricing, and also obtain price difference and a fit with risk appetite in advance.

An exchange business model may be supported through the risk movement transactions by a commission or by an exchange membership fee or through a similar arrangement. It is believed that the costs of an open exchange may be considerably lower and less error prone than the transfer processes in place today.

An exchange according to the present embodiments may use a predetermined data format, so that all incoming data is converted into the predetermined format which the platform is able to handle. Outgoing data may be converted from a single format to the format used by the data recipients. In an embodiment specifically intended for the insurance industry, the ACORD data format may be used, which is a standard agreed within the insurance industry. ACORD is an XML format, but the embodiments apply to XML formats in general and not just to ACORD.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

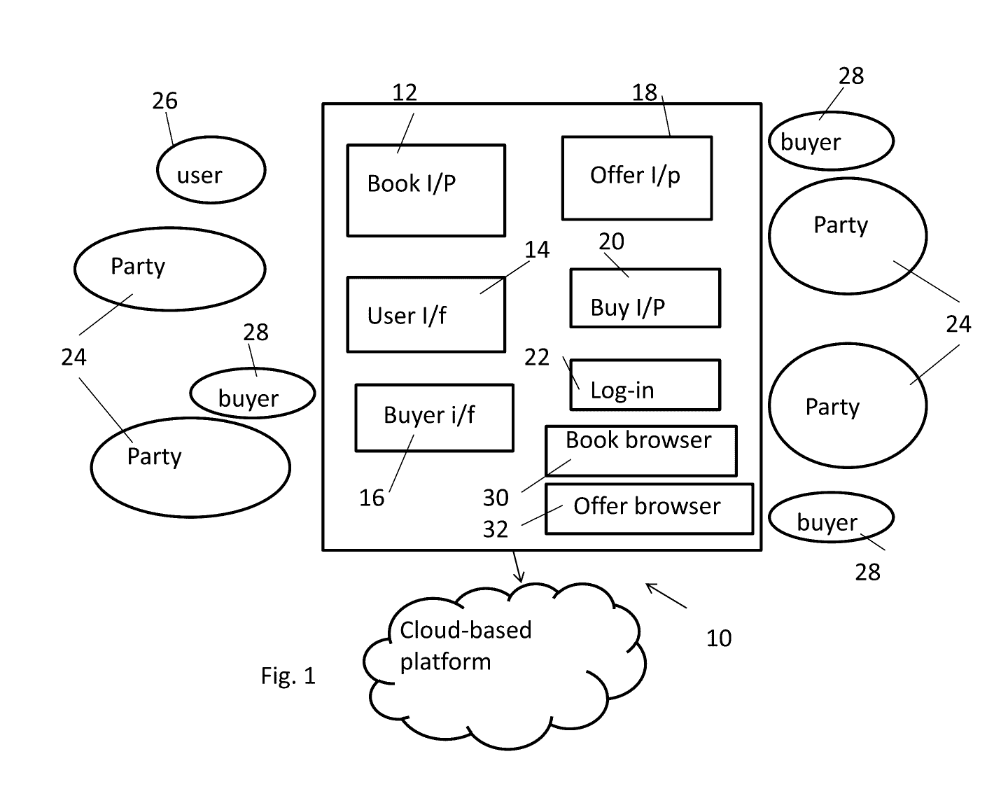

Referring now to the drawings, FIG. 1 illustrates a cloud-based platform 10 for electronic interaction between remote parties regarding a book over a network. The book is a book of business comprising a plurality of elements, such as separate contracts.

A first user input 12, herein denoted book input, may allow a first remote user to input the book including the individual elements of the book.

A user interaction interface 14 may allow said first remote user to evaluate said book and said plurality of elements.

A buyer interaction interface 16 allows remotely located potential buyers to electronically evaluate the book and the elements making up the book.

A user offer input 18 may allow the first remote user to make an offer for sale of the book.

A buy input 20 may allow one of the remote buyers to select all or part of a book and make an offer to buy the selected elements. As mentioned, the platform 10 may be a cloud based platform, and may for example be constructed using a software as a service (SaaS) cloud model.

The book may be a book of insurance contracts, in which case the elements are the individual insurance contracts. Each contract carries an element of risk, and insurance carriers may wish to sell a book under various circumstances. For example, the carrier needs cash to pay against sudden losses, or the carrier sees that its current risk profile requires correction.

The evaluation interfaces 14 and 16 may evaluate various issues of the contracts within the book, but in particular in the case of insurance contracts the evaluation may consider risks.

The user offer input 18 may allow the remote user to use evaluated risks of the book to set an offer price, and the buy input 20 may allow the potential buyer to evaluate the same contracts to help with the decision to accept or reject the offer. As an alternative the buyer may use the evaluation to make a counter offer.

The apparatus may comprise a log-in unit 22. The remote parties 24 may be insurance carriers or other relevant business entities. The first remote user 26 and the remote buyers 28 may be required to log in via the log-in unit 22, and the log in process may associate them with a corresponding one of the parties, for example the insurance carriers. The association may be internal, as a member of the party's staff, or may be weaker, as for example an independent insurance agent.

The apparatus may allow the book to be uploaded as separate elements or as a single computer file and the apparatus may accept several data formats. In particular, the platform may be able to interface between different proprietary formats of the particular parties.

The apparatus may include a book browsing interface 30 to allow buyers 28 to search through different books on said platform. The browsing interface may allow for searching according to definable risk or other criteria.

The apparatus may include an offer browsing interface 32 for browsing book offers. The buyers are not constrained to buy an entire book, but may be allowed to select different combinations of contracts that make up subsets of the book. Thus, the seller of the book may have to browse through different combinations of buyer offers in order to maximize the benefit of the sale.

The present embodiments are now considered in greater detail. Creating an exchange will provide sellers the ability to initially upload a set of policy information to a secure networked location, or alternatively to the cloud. The information uploaded may provide potential buyers with the ability to assess offers and ultimately transfer risk

As a result, buyers will be able to analyze and select sets of policies to purchase, and receive downloads of policy information. The information may be provided in batch form, or particular policies may be provided one by one, say upon renewal. The exchange requires clear and transparent information disclosure, so as to enable efficiency in the process of transferring risks from the seller.

The concept is to create an exchange where the carriers selling a book of business can upload a set of policy information to a secure cloud, and have buyers be able to analyze and select sets of polices to purchase from the selling carrier. The exchange would also support the download of policy information either in batch, or upon renewal so that risks can be transferred efficiently to the new carrier and removed from the selling carrier's book of business.

A particular embodiment of the exchange is implemented in a secure cloud. For example, a software as a service (SAAS) based cloud model may be used. As a result of use of the cloud no special software or data needs to be installed by end users.

The cloud implementation allows for real time trading and settlements which apply to all traders and are known about to all traders on equal terms.

Book of Business Analysis tools may be provided for book valuation purposes, so that both buyers and sellers can assess the books on offer on an equal basis.

Standard data formats may be applied for upload and download of policies, so that all data is available in the same way to all parties regardless of the systems used by the individual parties.

A real-time connection may be provided for quoting and issuance and other purposes.

Online monitoring of trades may be available within the exchange and analytics may be available. A dashboard may be provided for use by the exchange provider.

The buyer may be able to set a filter to help find the books of interest. Thus, a buyer may be able to use the exchange to buy books that fill a particular risk profile of interest.

The exchange may provide for transparent billing. For example, participants may pay a monthly subscription fee to buy or sell books, to access analytical tools and to obtain summarized reports. An additional nominal transaction fee, say based on a percentage of premium, may be applied, say for each trade of a policy. Thus, if a book of business has 500,000 polices, it would count as 500,000 transactions. Alternatively, a fee for the entire book may be charged, or a fee that is a percentage of the sale. The fee may for example be split between buyer and seller.

The transparent presentation of information may provide an ability to buy segments of books. The valuation tools may achieve more transparently based values for buyers and sellers.

Insurance policies are confidential, and the exchange may guarantee privacy and secrecy amongst the users or participants of the exchange. Participants may for example be able to share summarized information but not the full policy details.

The exchange may automate customer responses to transfer the books or book segments. During transfer, the exchange may automate policy information transfers into the buyer's carrier system.

An agent, or the seller itself, is then able to review multiple offers and bind the quote all without any redundant data re-entry.

As a result of using the present embodiments, buying and selling books become a simple task instead of a large scale project. The book exchange may provide an opportunity for both sellers and buyers to use a streamlined approach to manage risk by trading books.

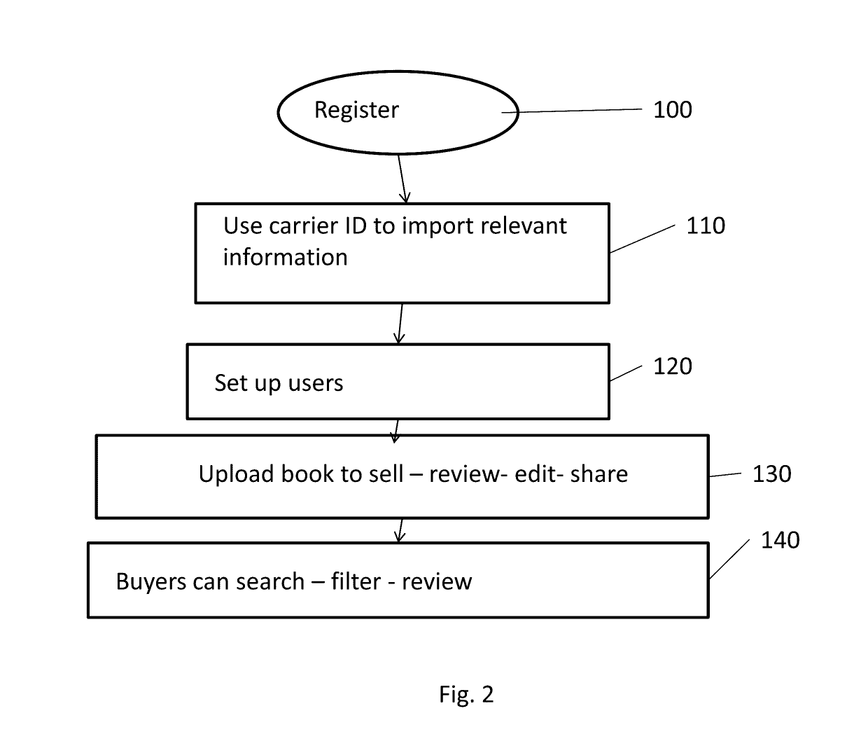

Reference is now made to FIG. 2, which is a simplified flow chart illustrating operation of a book transfer according to the present embodiments.

A carrier registers 100 with the exchange. The insurance industry has an identity system and the newly registered carrier may be identified by the unique Industry known Identity. For example, in the United States of America such an identity, hereinafter carrier ID, is provided by the National Association of Insurance Carriers (NAIC). The carrier Id may be used 110 to import relevant information about the carrier such as appointed agencies and agents, and an already registered carrier user may upload their own agents list.

The platform may retain the ability to change the carrier ID, for example in case of mergers and other reorganizations.

A single carrier may have several users associated with it. The users may be set up as shown in box 120, and each user may be provided with a user name, say an e-mail, and a password for future logins.

The various data obtained is now available for use by other carriers that want to buy policies for their existing, or yet to be appointed, agents. Agents may be able to use their license numbers as a unique identifier, say to match between carriers.

A duly registered carrier may, via a user, upload at any time a Book, that is a batch of policies they wish to sell 130. In an embodiment, a standard (ACORD based) API may be used for the upload to the secure cloud. The batch may be associated with the user's carrier ID.

Each individual policy in the book may include specific information such as:
Insured details;
Risk characteristics;
Premium and Coverage;
Renewal Date; and
Agent/Agency Id and commission amount may be an optional requirement.

The user may review the imported policies and approve the data as uploaded for sharing in the marketplace, or optionally edit the data prior to sharing. In addition, there may be an exception report for policies that have failed to load.

As part of the uploading or sharing, the user is able to define whether they are willing to sell the book as a whole or any part of it.

It may additionally be possible to define a minimum asking price for the book offered, either in absolute terms or as percentage of the premium, say in the case of a partial book sale.

As shown in box 140, potential buyers can search for and review Books for sale. Searches can be filtered by attributes such as:
Risk characteristics, where a 9 digit ZIP code may be available instead of the specific address for anonymity purposes;
Premium; or
Only Policies associated with agent/agencies that are appointed or that the carrier has indicated they are willing to appoint, either a full or a Limited Service Agreement (LSA) ( )appointment.

Alternatively, policies may be presented in a list with different filters, also per carrier, although the selling carrier name may be masked.

The user may price the policies in the Book for sale through the platform of the present embodiments, as long as the carrier associated with the user is integrated into the Platform.

A user may export selected policies into Excel™ or like external programs for further analysis.

Regarding buying, a user may place an offer to buy all or part of a book appearing on the platform for a given price. A link to the offer may be sent to the seller via e-mail. A user can review offers for the carrier's policies that are for sale. The user can approve/reject an offer (fully or partially), and a link to approval/rejection will be sent to the representative of the buyer via e-mail.

Once the transfer is agreed, there are two ways that the policies can be transferred. The transfer can be made with effect from the next renewal, in which case, X days before renewal is due bought policies are transferred through the issuance service. The alternative is immediate transfer so that responsibility for covering the risk is transferred immediately. The pro-rata of the premium for the remaining period modified by the offered amount may be charged to the buyer and transferred to the seller minus any commission.

Elements of the Exchange

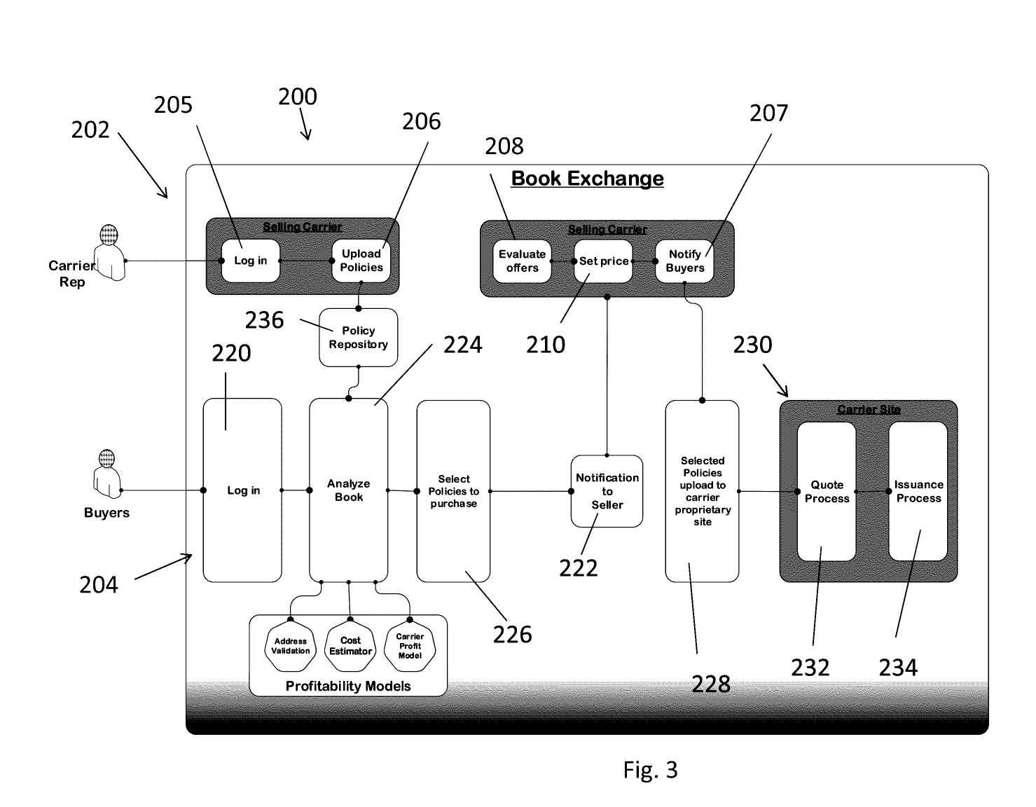

Reference is now made to FIG. 3, which shows the elements of the platform, or exchange, according to one embodiment of the present invention. The exchange 200 has elements 202 for the seller and elements 204 for the buyer. The seller may be required to log in 205. For the seller the exchange may set up a book of business package for sale, may upload a policy to shared formats 206, may invite carriers to bid on available risks 207, may provide book of business valuation tools to support selection and tagging of risk, and may provide Audit trail reporting. In addition, the platform may include messaging for collaboration with buyers, document management to store and share supporting documentation, reporting and analytics for the transfer of risks and regulatory reporting. The seller may be able to evaluate offers 208, and set a price 210.

For the buyer, the platform may again require logging in 220. The buyer part may provide a summary view of books of business available for purchase, and may allow the potential buyer to communicate interest 222 in participation in transfers. The buyer may also have book of business valuation tools to support the selection and tagging of individual risks and sets of risks, say based on specified criteria. Audit trail reporting, messaging for collaboration with sellers, document management to store and share supporting documentation, and reporting and analytics for the transfer of risks may also be provided as well as regulatory reporting. The buyer may analyze the books for sale using analytic tools which are provided with the platform, 224, may select policies, that is a book or part of a book, for purchase, 226, and notify the seller as discussed. Once the purchase is made then the selected policies may be uploaded to the proprietary site of the new carrier, and the uploading interface may convert the data file from the platform format to the proprietary format of the carrier site 228. The carrier site is then responsible for its own processes of quote 230 and issuance 232 of the newly acquired policies.

Pending books are retained by the platform in a platform defined format in policy repository 236 from the time they are uploaded until no longer required.

The present embodiments may provide a multi-channel, multi-carrier software distribution platform that enables insurance carriers and distributors to operate together, thus enabling them to jointly drive market share, retention and revenue in an end-to-end environment, from preparing a quote to issue to providing service to the insured customer. The platform may connect distribution channels to markets to support the need and requirement of customers seeking protection. The platform may conveniently be based in the cloud and may use secure connections for agents to place risks with multiple markets.

### Brief Description of Technology

Features of the platform may include:
Automated data prefill
Single entry for multiple, bindable quotes
Clear comparison of offers
Single sign on—direct bridge to carriers for binding
Monitoring and management analytics for all transactions
Ability to support ACORD data formats

The platform may rely on business rules that are flexible and can be easily updated to offer bindable offers of coverage. The present embodiments make use of .net as well as java based web services which orchestrate each transaction, utilizing parallel processing wherever possible. A rating response may thus be possible in 30 seconds or less. The result is a bindable quote that can be issued directly online. The platform may be load balanced for high availability and may contain robust reporting capabilities. The carriers may be integrated in real time and the quotes provided are bindable quotes, thus providing ease of use for agents, making it possible to collect information and provide the right options for their customers. A single application can result in three or four quotes, with ineligible risks removed to increase the efficiency in matching customers to the right markets. For the Agents the complete platform may be web-based and may be accessed equally well from a web browser on a PC or Tablet.

An embodiment may be based on software as a service (SaaS), which means that all integration, database, security, network, hardware and upgrade activities and enhancements are included in the platform, which increases stability of the platform and provides predictable operating costs.

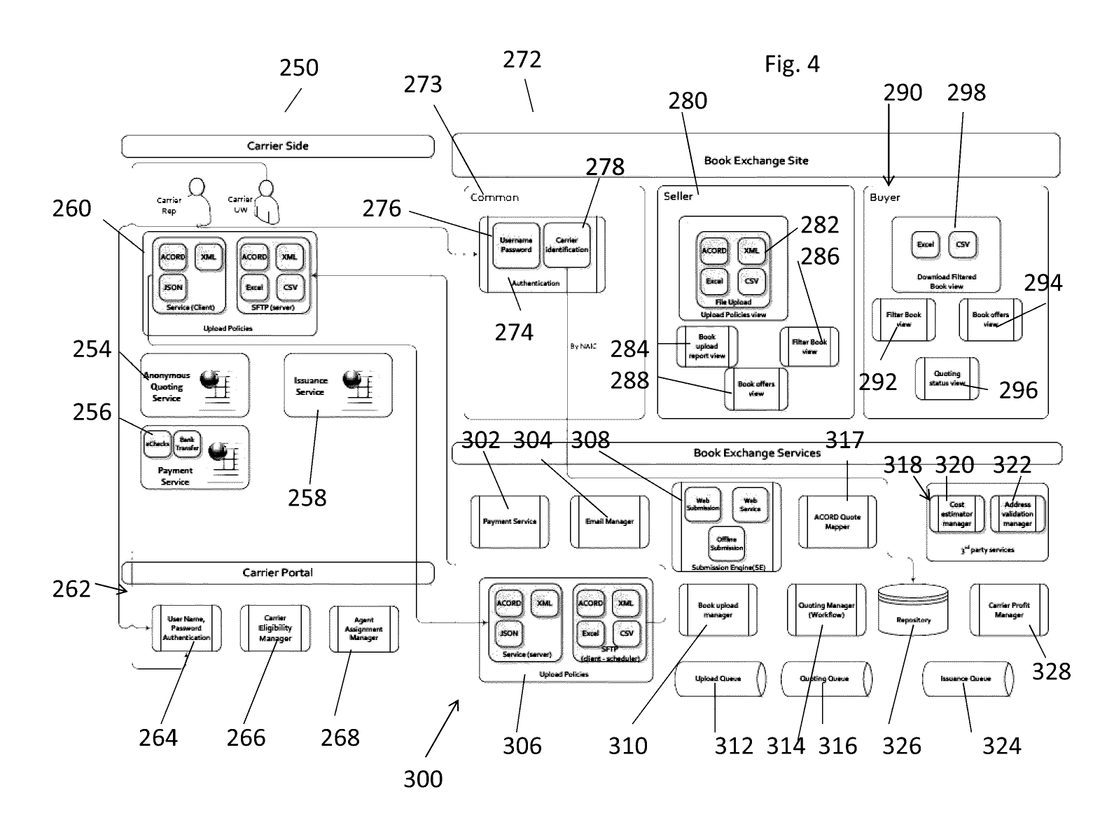

Reference is now made to FIG. 4, which is a simplified block diagram of an embodiment of the platform of FIG. 3 showing the different formats and blocks that work on the given formats. A carrier side 250 interacts with the book exchange 252. The carrier side has its own quoting 254, payment 256 and issuance 258 services, and upload policies for different formats 260 for client and server.

A carrier portal 262 deals with authentication 264, deals with carrier eligibility 266 and manages agent assignment 268.

Book exchange site 252 comprises a common part 273 which includes authentication 274. The authentication part authenticates the user via username and password 276 and identifies the corresponding carrier 278.

A seller part 280 provides for upload in from the seller in different formats 282, and offers three views, a book upload report view 284, a filter view 286 and a book offer view 288. A buyer part 290 provides a filter book view 292, a book offer view 294, a quote status view 296 and a facility 298 for downloading the filtered book in more than one format.

Book exchange services 300 provided with the platform include payment services 302, an email manager 304, upload policies 306, a submission engine 308 that allows for web submission, web service and offline submission, and book upload manager 310, that operates on upload queue 312. Quoting manager 314 works with quoting queue 316 and Acord quote mapper 317. Third party services 318 such as cost estimate 320 and address validation 322 may be provided, and issuance queue 324 may contain the books currently in the process of being transferred to the buyers. Books being handled are kept in repository 326. The carrier business side is managed by carrier profit manager 328.

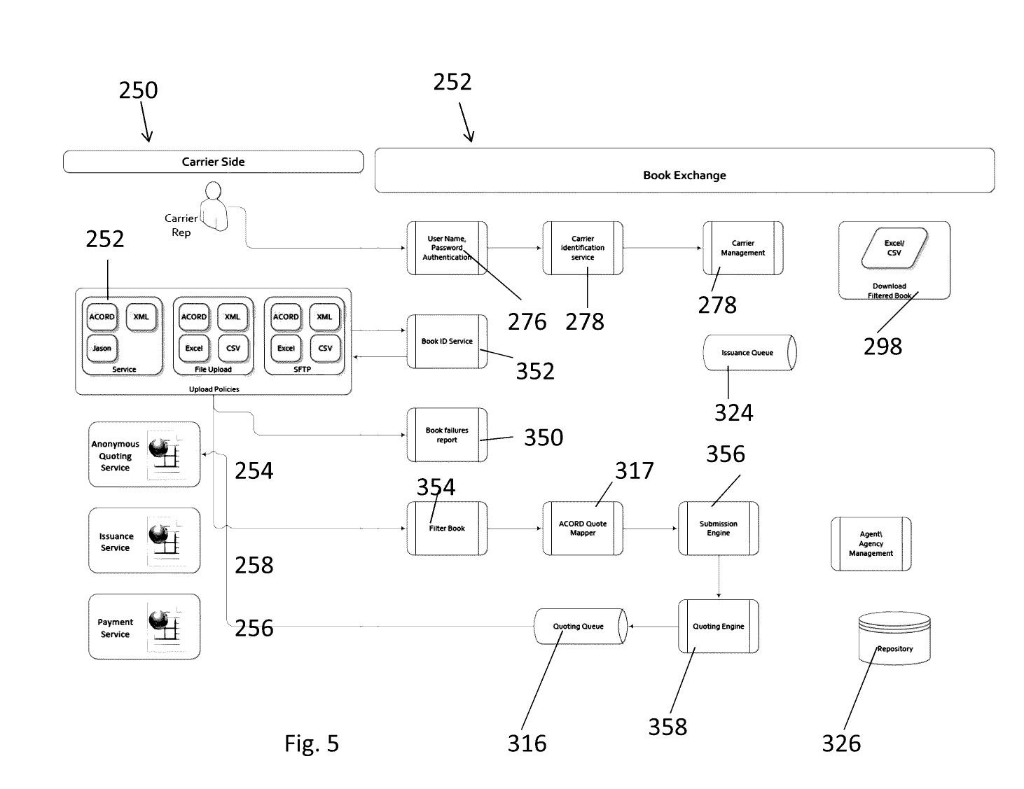

Reference is now made to FIG. 5, which is a block diagram showing in greater details some of the blocks of FIG. 4. Parts that are the same as in FIG. 4 are given the same reference numerals and are not described again except as needed for an understanding of the present embodiment.

A book failures report section 350 reports when books fail to download or to fit in with the format and other requirements or the like. Book ID service 352 keeps track of what the book is and where it has come from. A filter book service 354 operates on uploading books prior to mapping, say of risk, for quotes at quote mapper 317. Submission engine 356 and quoting engine 358 allow for submission and quoting and the quotes received from the buyers are placed in quoting queue 316. The quoting queue may then be submitted to the anonymous quoting services 254 at the carrier side so that the buyer and possibly the seller get to see the quotes. Agents, as external associates of a carrier are managed at agency management 360 and may have limited rights based on their associated carrier.

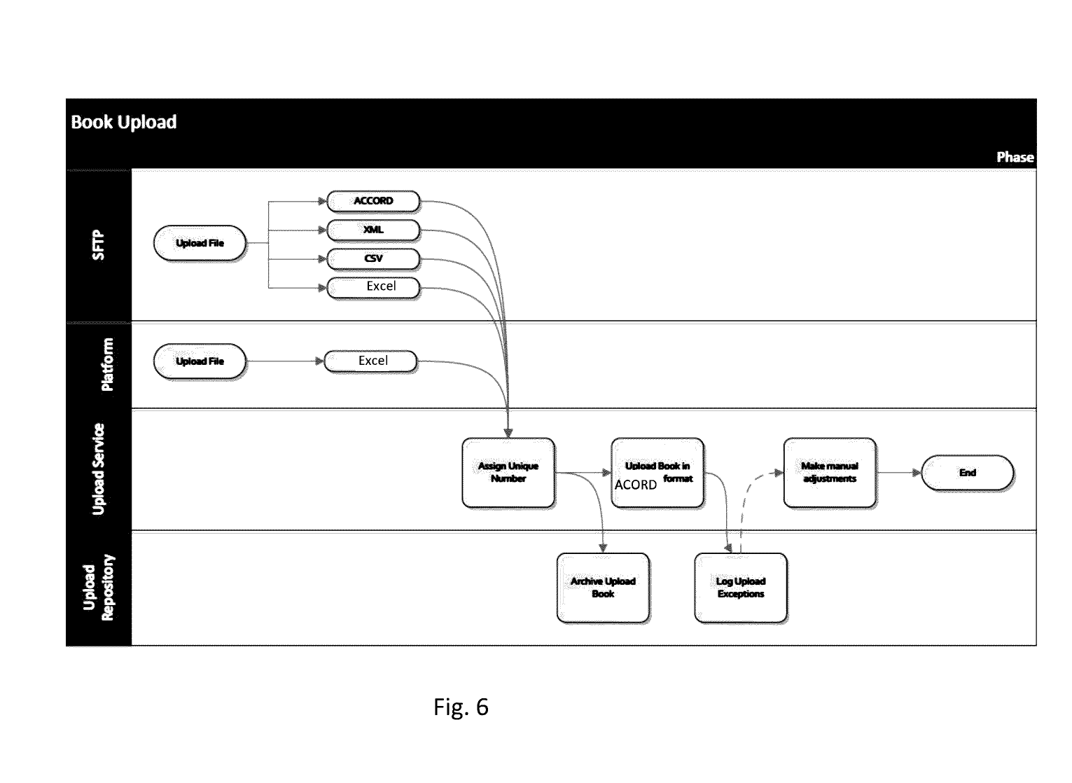

Reference is now made to FIG. 6, which is a simplified flow diagram illustrating the various stages of book upload. The book may be in a number of formats and is uploaded to the platform, assigned a unique number, placed into the platform format, in this example the Acord format. Manual adjustments are made as necessary, say if some information is not correctly recognized in the formatting process. An exceptions log is provided and the book is archived.

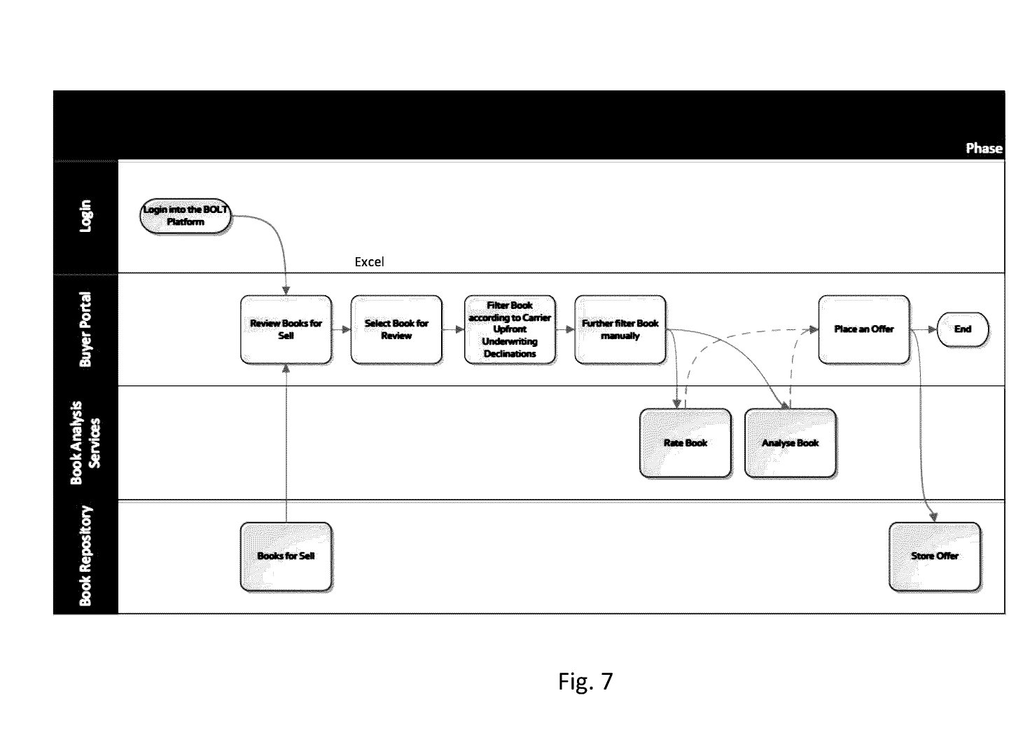

Reference is now made to FIG. 7, which is a simplified flow diagram showing the process of placing an offer for a book. The user logs into the platform, reviews the books for sale, selects a particular book for further review, where the selecting may involve filtering in particular for various aspects of risk. If a particular parameter is not provided by the filter as provided than manual filtering is also possible. The user is able to rate and analyze the books and policies and place an offer, which is stored.

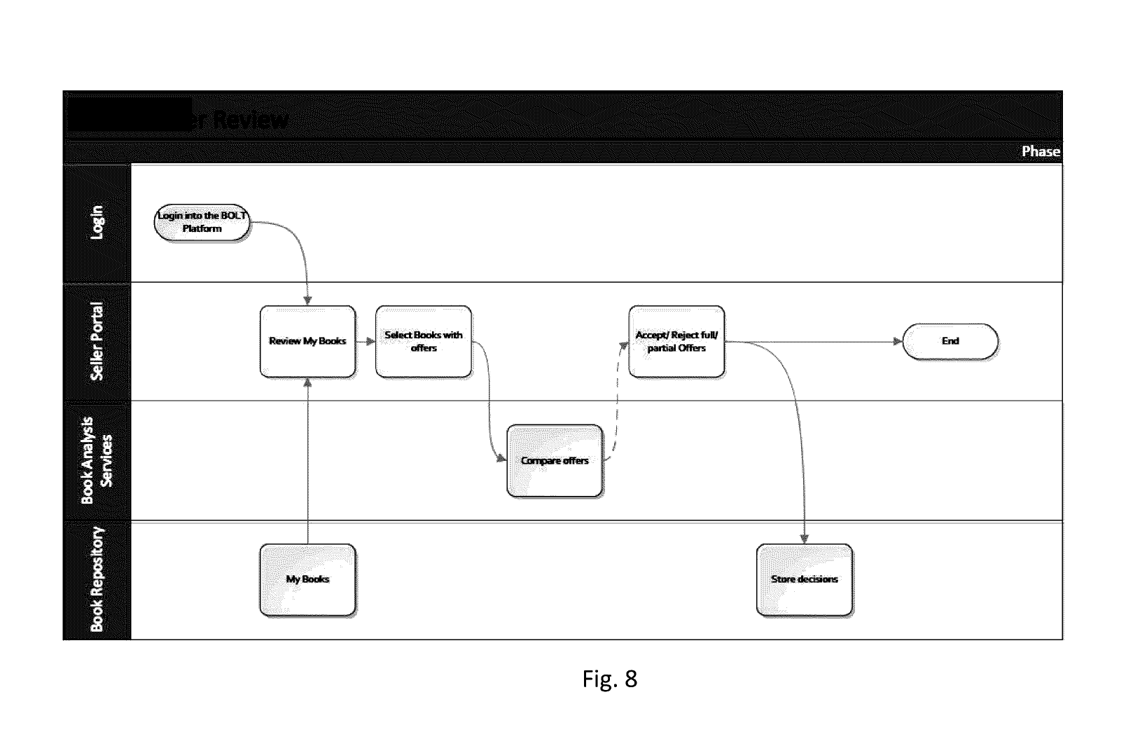

Reference is now made to FIG. 8 which is a simplified flow diagram indicating how a seller may review and accept or reject available offers. The seller views the books, selects books with offers, compares the offers, and carries out full or partial acceptance or rejection of the offers.

The decisions are stored.

It is expected that during the life of a patent maturing from this application many relevant platform-based technologies and SaaS and cloud based technologies will be developed and the scope of the corresponding terms are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment, and the above description is to be construed as if this combination were explicitly written. Conversely, various features of the invention, which are, for brevity, described in the context of a single embodiment, may also be provided separately or in any suitable subcombination or as suitable in any other described embodiment of the invention, and the above description is to be construed as if these separate embodiments were explicitly written. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. Apparatus for electronic interaction between remote parties regarding a book over a network, the book comprising a plurality of elements, the apparatus comprising:
a first user input configured to receive an electronic signal to allow a first remote user to input said book including said plurality of elements;
a user interaction interface to receive an electronic signal to allow said first remote user to evaluate said book and said plurality of elements;
a buyer interaction interface to receive an electronic signal to allow any one of a plurality of remotely located potential buyers to evaluate said book and said plurality of elements;
a user offer input to receive an electronic signal to allow said first remote user to make an offer for sale of said book; and
a buy input to receive an electronic signal to allow one of said remote buyers to:
make a selection comprising one member of the group consisting of:
one of said plurality of elements of said book;
at least two of said plurality of elements of said book; and
all elements of said book; and
to offer to buy said selected elements.

2. The apparatus of claim 1, constructed using a software as a service cloud model.

3. The apparatus of claim 1, wherein said elements are insurance contracts and said book is a book of insurance contracts.

4. The apparatus of claim 3, wherein said insurance contracts carry risk and said evaluation interfaces are configured to evaluate respective risks.

5. The apparatus of claim 4, wherein said user offer input is configured to allow said first remote user to use evaluated risks of said book to set an offer price.

6. The apparatus of claim 4, comprising a log-in unit, wherein said remote parties are insurance carriers and said first remote user and said plurality of remote buyers are respectively required to log in via said log-in unit as being associated with a corresponding one of said insurance carriers.

7. The apparatus of claim 1, wherein said first user input is configured for uploading said book as a plurality of said elements in a plurality of formats.

8. The apparatus of claim 1, further comprising a book browsing interface to allow said prospective buyers to search through different books on said platform.

9. The apparatus of claim 1, wherein said elements comprise risk carrying insurance contracts and said browsing interface is configured to allow for searching according to definable risk criteria.

10. The apparatus of claim 1, further comprising an offer browsing interface for browsing book offers.

11. Method for electronic interaction between remote parties regarding a book over a network, the book comprising a plurality of elements, the method carried out on an electronic process connected to said remote users via said network, the method comprising:
receiving an electronic signal to allow a first remote user to input said book including said plurality of elements;
receiving an electronic signal to allow said first remote user to evaluate said book and said plurality of elements;
receiving an electronic signal to allow any one of a plurality of remotely located potential buyers to evaluate said book and said plurality of elements;
receiving an electronic signal to allow said first remote user to make an offer for sale of said book; and
receiving an electronic signal to allow one of said remote buyers to:
make a selection comprising one member of the group consisting of:
one of said plurality of elements of said book;
at least two of said plurality of elements of said book; and
all elements of said book; and
to offer to buy said selected elements.

12. The method of claim 11, comprising using a software as a service cloud model.

13. The method of claim 11, wherein said elements are insurance contracts and said book is a book of insurance contracts.

14. The method of claim 13, wherein said insurance contracts carry risk and said evaluation interfaces are configured to evaluate respective risks.

15. The method of claim 14, comprising allowing said first remote user to use evaluated risks of said book to set an offer price.

16. The method of claim 14, wherein said remote parties are insurance carriers and said first remote user and said plurality of remote buyers are respectively required to log in as being associated with a corresponding one of said insurance carriers.

17. The method of claim 11, comprising uploading said book as a plurality of said elements in a plurality of formats.

18. The method of claim 11, further comprising allowing said prospective buyers to search through different books on said platform.

19. The method of claim 11, wherein said elements comprise risk carrying insurance contracts, the method comprising allowing for searching according to definable risk criteria.

20. The method of claim 11, further comprising browsing of book offers.
